(19) United States
(12) Patent Application Publication
(10) Pub. No.: US 2002/0051605 A1
(43) Pub. Date: May 2, 2002

(54) Ring network system and method of transmitting a signal therein capable of using band of optical fiber effectively

(75) Inventor: Mitsuhiro Kitagawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/015,969

(22) Filed: Nov. 1, 2001

(30) Foreign Application Priority Data
Nov. 1, 2000 (JP) 2000-334079

(51) Int. Cl. G02B 6/28; G02B 6/293; H04J 14/02

(52) U.S. Cl. 385/24; 359/127

(57) ABSTRACT

In a ring network system, working paths P1-1, P1-2, P1-3, . . . , P1-n between the ADM devices N1 to Nn are established on the same channel C1-1 within a working optical fiber 101, a signal between the ADM devices N1 to Nn is composed of a multi-frame in a protection optical fiber 102, protection paths co-use a band of one channel C2-1.

### BACKGROUND OF THE INVENTION

The present invention relates to a ring network system and a method of transmitting a signal in the ring network system.

Conventionally, a network system capable of synchronous and multiplex transmission of information, such as SONET (Synchronous Optical Network) or SDH (Synchronous Digital Hieraky) has been developed. The SONET is a standard system in North America while SDH is an internationally standard system around Europe A ring network system has been developed as such the synchronous and multiplex network system. In the ring network system, a plurality of ADM (Add-Drop Multiplexer) devices, each of which is a relay or a terminal device for signals, are connected to each other like a ring, so that information are transmitted clockwise or counterclockwise around the ring. Examples of the ring network system are disclosed in unexamined Japanese Patent Publications Hei 9-247197, namely 247197/1997 and 2000-78174, namely 78174/2000.

When data traffics [IP (Internet Protocol)] are transferred in the ring network system, it is possible to use such an application software that establish paths hop by hop. When paths are established hop by hop in a conventional path protection type ring network system, such as UPSR (Bellcore GR-1400-CORE)/SNC-P (ITU-T G.841), and the like, a constitution of the path protection type makes it necessary that paths between a plurality of ADM devices are established on channels different from each other in an optical fiber.

Accordingly, as will later be described more in detail, when a plurality of paths are established on a channel of a working optical fiber, it becomes impossible that protection paths are established in a protection optical fiber. Therefore, when n paths are to be established, respective n channels must be used not only in the working optical fiber but also in the protection optical fiber. Consequently, many unusable bands inevitably exist. This causes a problem that bands are used so ineffectively.

### SUMMARY OF THE INVENTION

It is therefore an object of the present invention to provide a ring network system and a method of transmitting a signal in the ring network system which are capable of improving an efficiency of use of the bands in an optical fiber.

It is another object of the present invention to provide a path protection type ring network system and a method of transmitting a signal in the path protection type ring network system which are capable of improving an efficiency of use of the bands in an optical fiber, when paths are established hop by hop in the path protection type ring network system.

Other objects of the present invention will become clear as the description proceeds.

According to an aspect of the present invention, there is provided a ring network system, comprising: a working optical fiber; a protection optical fiber; a plurality of Add-Drop Multiplexer devices which are connected to each other like a ring by said working optical fiber and said protection optical fiber; a working signal being transmitted in said working optical fiber to one side thereof; a protection signal being transmitted in said protection optical fiber to the other side thereof; working paths between said a plurality of Add-Drop Multiplexer devices being established on the same channel within said working optical fiber; and protection paths between said a plurality of Add-Drop Multiplexer devices co-using a band of one channel within said protection optical fiber.

The protection paths between said a plurality of Add-Drop Multiplexer devices may be composed of a multi-frame

The working paths may be composed of SONET/SDH frames, each of said a plurality of Add-Drop Multiplexer devices extracting data packet from said SONET/SDH frames and locating the extracted data packet in a corresponding frame of said protection path.

Each of said a plurality of Add-Drop Multiplexer devices may extract the data packet from said corresponding frame of said protection path and may locate the extracted data packet in said SONET/SDH frames.

According to another aspect of the present invention, there is also provided a method of transmitting a signal in a ring network system having a working optical fiber, a protection optical fiber, and a plurality of Add-Drop Multiplexer devices which are connected to each other like a ring by said working optical fiber and said protection optical fiber, a working signal being transmitted in said working optical fiber to one side thereof, a protection signal being transmitted in said protection optical fiber to the other side thereof, said method comprising the steps of: establishing working paths between said a plurality of Add-Drop Multiplexer devices on the same channel within said working optical fiber; and making protection paths between said a plurality of Add-Drop Multiplexer devices co-use a band of one channel within said protection optical fiber.

The protection paths between said a plurality of Add-Drop Multiplexer devices may be composed of a multi-frame

The working paths may be composed of SONET/SDH frames, each of said a plurality of Add-Drop Multiplexer devices extracting data packet from said SONET/SDH frames and locating the extracted data packet in a corresponding frame of said protection path.

Each of said a plurality of Add-Drop Multiplexer devices may extract the data packet from said corresponding frame of said protection path and may locate the extracted data packet in said SONET/SDH frames.

### BRIEF DESCRIPTION OF THE DRAWINGS

FIG. 1 is a diagram for schematically showing a status of establishing working paths in a conventional ring network system;

FIG. 2 is a diagram for schematically showing a status of establishing protection paths in the conventional ring network system;

FIG. 3 is a diagram for schematically showing a constitution of a ring network system in which a method of transmitting a signal according to a first embodiment of the present invention is used;

FIG. 4 is a diagram for showing a frame structure of a signal used in the method according to the first embodiment of the present invention;

FIG. 5 is a diagram for schematically showing a constitution of a ring network system in which a method of transmitting a signal according to the first embodiment of the present invention is used;

FIG. 6 is a diagram for schematically explaining an operation of the ring network system in which the method according to the first embodiment of the present invention is used;

FIG. 7 is a diagram for schematically explaining an operation of the ring network system in which the method according to the first embodiment of the present invention is used;

FIG. 8 is a diagram for schematically showing a status of establishing working paths in the ring network system in which the method according to the first embodiment of the present invention is used;

FIG. 9 is a diagram for schematically showing a status of establishing protection paths in the ring network system in which the method according to the first embodiment of the present invention is used; and

FIG. 10 is a diagram for schematically showing a constitution of a ring network system in which a method of transmitting a signal according to a second embodiment of the present invention is used.

### DETAILED DESCRIPTION OF THE PREFERRED EMBODIMENTS

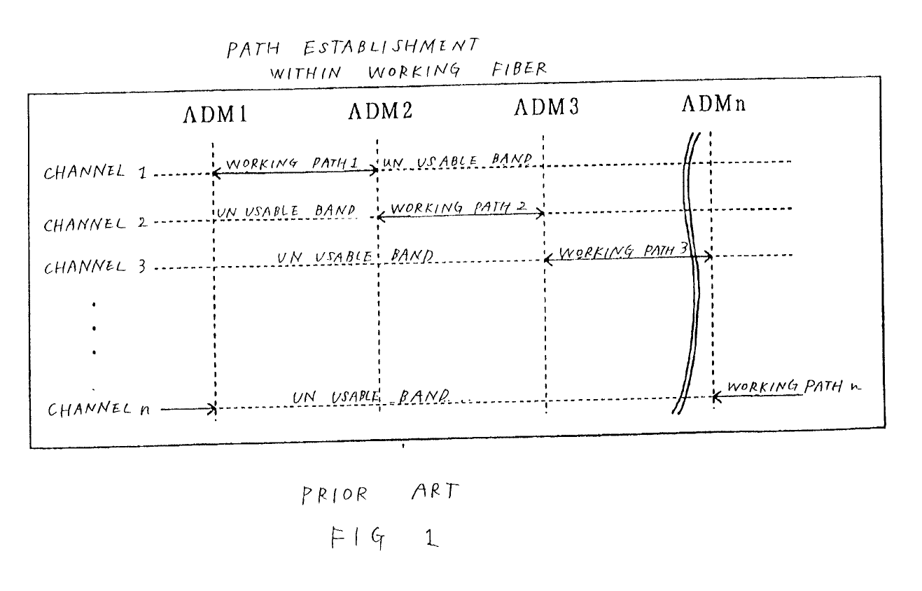

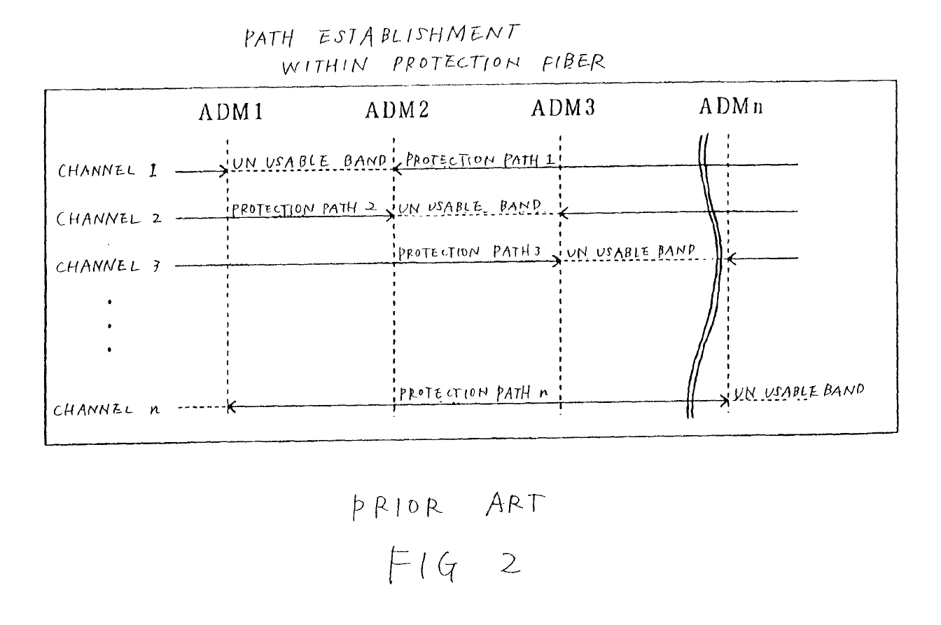

Referring to FIGS. 1 and 2, description is, at first made about a conventional ring network system and a conventional method of transmitting a signal in the ring network system in order to facilitate an understanding of the present invention.

As mentioned in the preamble of the instant specification, when data traffics [IP (Internet Protocol)] are transferred in the ring network system, it is possible to use such an application software that establish paths hop by hop. When paths are established hop by hop in a conventional path protection type ring network system, such as UPSR (Bellcore GR-1400-CORE)/SNC-P (ITU-T G.841), and the like, a constitution of the path protection type makes it necessary that paths between a plurality of ADM devices are established on channels different from each other in an optical fiber. This problem is hereunder described with reference to FIGS. 1 and 2. In the conventional path protection type ring network system, FIG. 1 shows a status of establishing working paths while FIG. 2 shows a status of establishing protection paths.

As illustrated in FIGS. 1 and 2, paths are established in a working optical fiber hop by hop between n ADM devices 1 to n, such as between ADM devices 1 and 2, ADM devices 2 and 3, . . . , ADM devices n-1 and n, and so on. In this case, also in a protection optical fiber, protection paths are established on the same channel as that of the working optical fiber. As a result, when a plurality of paths are established on one channel of the working optical fiber, it becomes impossible that protection paths are established in the protection optical fiber.

For example, as illustrated in FIG. 1, let a working path 1 be established on a working channel 1 between ADM devices 1 and 2. Consequently, a protection path is established between ADM devices 1 and 2 as shown in FIG. 2, since the protection path turns oppositely to the working path Then, a band from ADM device 2 to ADM device 1 on the working channel 1 becomes unusable. Further, a band from ADM device 1 to ADM device 2 on the protection channel 1 also becomes unusable.

Accordingly, when a plurality of paths are established on a channel 1 of the working optical fiber, it becomes impossible that protection paths are established in the protection optical fiber. Therefore, when n paths are to be established, respective n channels must be used not only in the working optical fiber but also in the protection optical fiber. Consequently, many unusable bands inevitably exist, This causes a problem that bands are used so ineffectively.

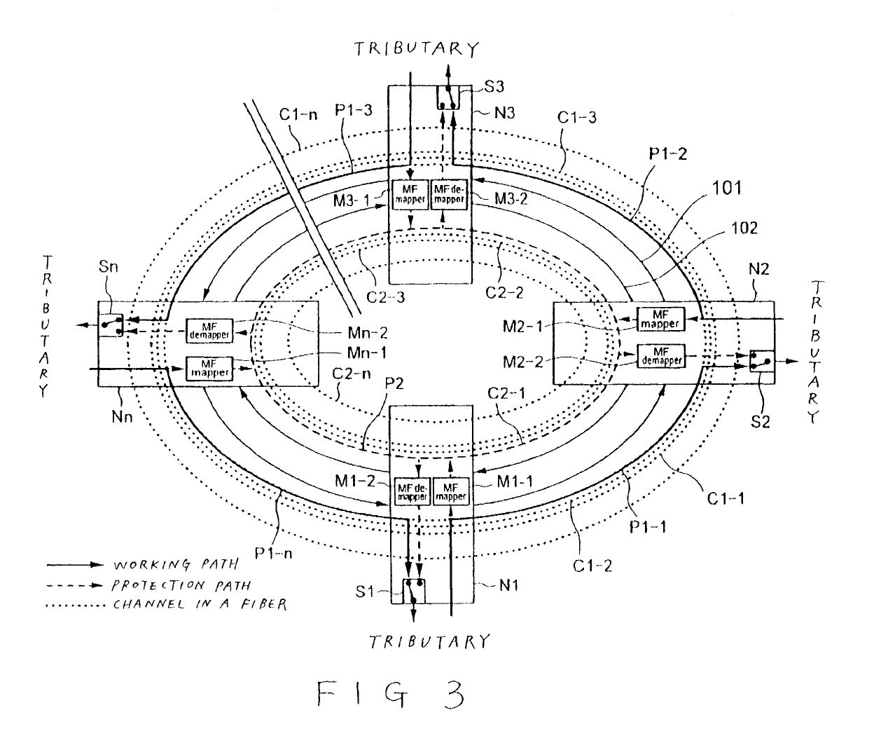

Now, referring to FIG. 3, description will proceed to a ring network system and a method of transmitting a signal in the ring network system according to a first embodiment of the present invention. FIG. 3 is a diagram for schematically showing a constitution of a path protection type ring network system in which the method of transmitting a signal according to the first embodiment of the present invention is used.

In FIG. 3, illustrated is an example of a ring network system composed of n ADM devices N1 to Nn in which paths are established hop by hop. As illustrated in FIG. 3, n ADM devices N1 to Nn are connected to each other like a ring by a working optical fiber 101 as a transmission line and a protection optical fiber 102 as a transmission line. In the example, each path is previously established in each of the ADM devices N1 to Nn. A working signal is transmitted through a predetermined working channel within the working optical fiber 101 to one [East] side of the working optical fiber 101, that is, counterclockwise in FIG. 3.

At the same time, a protection signal is transmitted through a predetermined protection channel (a channel of the same number as the predetermined working channel) within the protection optical fiber 102 to the other [West] side of the protection optical fiber 102, that is, clockwise in FIG. 3. Each of n ADM devices N1 to Nn is operable to drop the working signal transmitted within the working optical fiber 101, when communication trouble is not caused to occur. On the other hand, each of n ADM devices N1 to Nn is operable to drop the protection signal transmitted within the protection optical fiber 102, when communication trouble is caused to occur. Besides, each of n ADM devices N1 to Nn detects whether or not the communication trouble is caused to occur.

A plurality of working channels C1-1 to C1-n are established in the working optical fiber 101 while a plurality of protection channels C2-1 to C2-n are established in the protection optical fiber 102. A plurality of working paths P1-1, P1-2, P1-3, . . . , P1-n between the ADM devices N1 to Nn are assigned to one channel C1-1 within the working optical fiber 101.

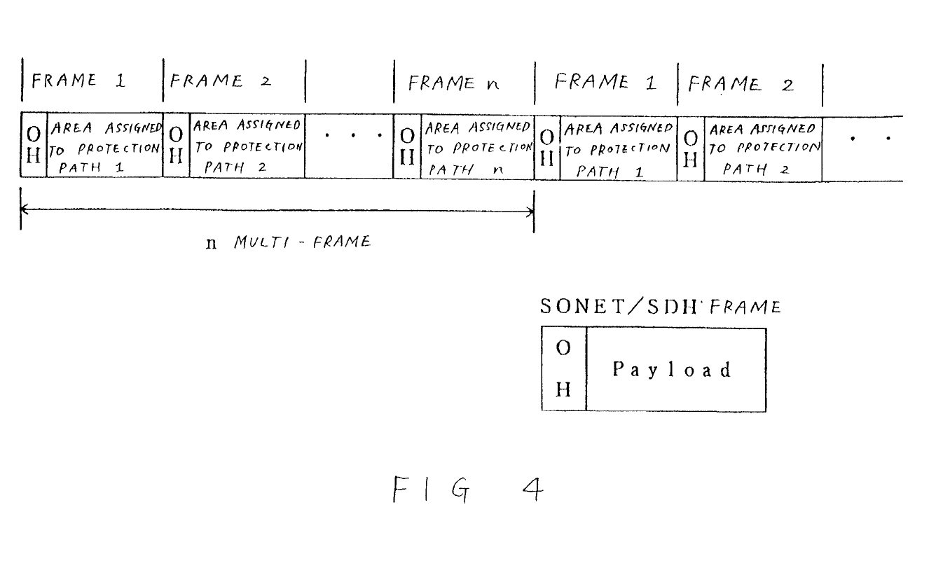

FIG. 4 shows a path P2 which passes through one protection channel C2-1 within the protection optical fiber 102. As illustrated in FIG. 4, the path P2 passing through one protection channel C2-1 within the protection optical fiber 102 is composed of a multi-frame by the numbers of paths n existing in the ring network system. Each frame of the multi-frame is assigned as a band for a respective protection path. Thereby, one path P2 includes a protection path 1, a protection path 2, . . . ) a protection path n. In other words, in a format of the protection signal, one path P2 is multiplexed by n paths with the n multi-frame structure. In this embodiment, the path P2 is hereunder called “multi-frame common path”. Besides, each frame is SONET/SDH frame that is composed of overhead (OH) and payload (PL).

Herein, the multi-frame common path P2 is co-owned by n paths existing in the ring network system. Consequently, a band assigned to each path becomes 1/n. Accordingly, this embodiment can be preferably applied to data (IP) traffic in which a throughput of traffics to be transmitted can be adjusted by an upper protocol.

Two functional blocks are provided in each of the ADM devices N1 to Nn to carry out processing for the multi-frame common path P2. A first functional block is each mapping section (MF mapper) M1-1 to Mn-1 which carries out a mapping operation for locating data packet within a path inputted by the SONET/SDH frame format on a predetermined corresponding frame of the multi-frame common path of n multi-frame structure. A second functional block is each demapping section (MF demapper) M1-2 to Mn-2 which carries out a demapping operation for extracting only its own data packet from the corresponding frame of the inputted multi-frame common path and mapping(demapping) the extracted data packet on an output path. In addition, each selector S1 to Sn is provided in each of the ADM devices N1 to Nn. Each selector S1 to Sn selects one of the working path and the protection path and then outputs the selected one to the side of TB (Tributary) channel.

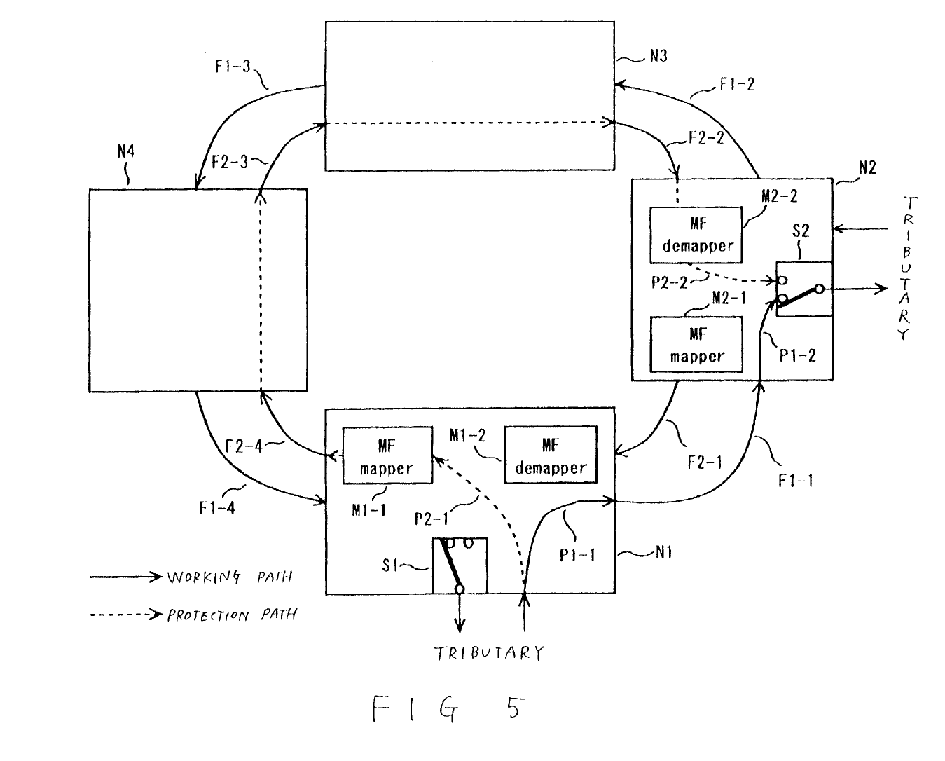

In FIG. 5, illustrated is an example in which numbers of node (n)=4, namely, numbers of ADM devices are four. As illustrated in FIG. 5, the ADM devices N1 to N4 are connected to each other like a ring by working optical fibers F1-1 to F1-4 and protection optical fibers F2-1 to F2-4. Each of the ADM devices N1 to N4 includes a mapping section (MF mapper), a demapping section (MF demapper), and a selector. For example, the ADM device N1 includes a mapping section (MF mapper) M1-1, a demapping section (MF demapper) M1-2, and a selector S1 while the ADM device N2 includes a mapping section (MF mapper) M2-1, a demapping section (MF demapper) M2-2, and a selector S2. Namely, each of the ADM devices N1 to N4 includes a mapping section (MF mapper) which extracts data packet from the SONET/SDH frame inputted from the side of TB (Tributary) channel and which carries out a mapping operation for locating the extracted data packet on a corresponding frame of the protection path of the multi-frame structure to output the data packet to a protection optical fiber at the side of Aggregate. Further, each of the ADM devices N1 to N4 includes a demapping section (MF demapper) which extracts the data packet from the corresponding frame of the protection path of the multi-frame structure and which carries out a mapping operation for locating the extracted data packet on the SONET/SDH frame to output the data packet to the side of TB (Tributary) channel. Furthermore, each of the ADM devices N1 to N4 includes a selector. The selector selectively outputs a working signal to the side of TB (Tributary) channel, when communication condition is normal. On the contrary, the selector selectively outputs a protection signal to the side of TB (Tributary) channel, when communication condition becomes abnormal.

As illustrated in FIG. 5, the ADM device N1 transmits a path inputted (Added) from the side of TB (Tributary) channel to a working optical fiber F1-1 as a path P1-1. In addition, the ADM device N1 also transmits the path inputted (Added) from the side of TB (Tributary) channel to a protection optical fiber F1-4 as a path P2-1 through the mapping section (MF mapper) M1-1.

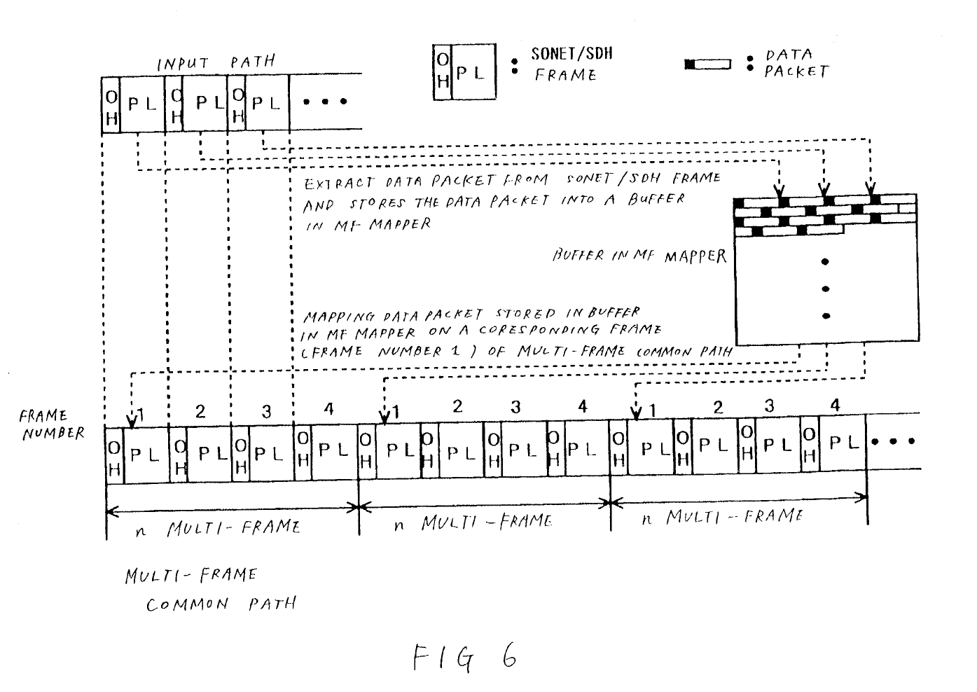

FIG. 6 is a diagram for schematically explaining a mapping operation by the mapping section (MF mapper) M1-1. As illustrated in FIG. 6, the mapping section (MF mapper) M1-1 carries out a mapping operation for locating data packet within an inputted path on a predetermined corresponding frame (Herein, frame number 1) of the multi-frame common path. The ADM device N2 drops a path P1-2 from the working optical fiber F1-1 and a path P2-2 from the mapping, section (MF mapper) M2-2 to the side of TB (Tributary) channel, so that the selector S2 selects the path Pi-2 from the working optical fiber F1-1 or the path P2-2 from the mapping section (MF mapper) M2-2. Besides, the SONET/SDH frame is composed of overhead (OH) and payload (PL). In addition, n is numbers of the nodes (ADM devices) in the ring network system.

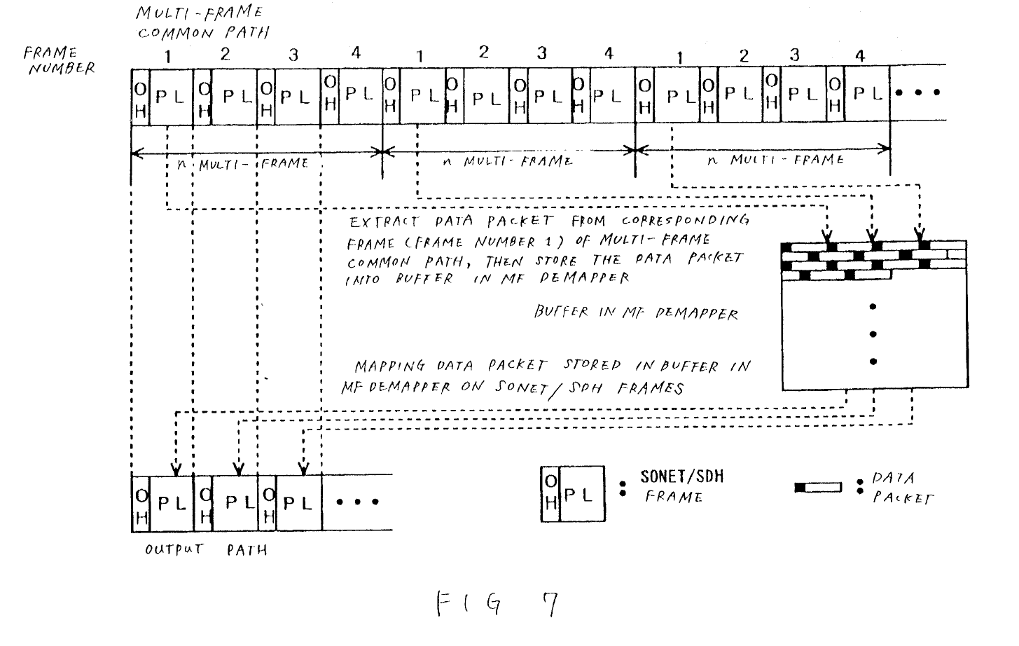

FIG. 7 is a diagram for schematically explaining a demapping operation by the demapping section (MF demapper) M2-2. As illustrated in FIG. 7, the demapping section (MF demapper) M2-2 extracts only its own data packet from the corresponding frame (Herein, frame number 1) of the inputted multi-frame common path to carry out a mapping operation of the own data packet on an output path. At this time, when a trouble is detected in the path P1-2 received by the ADM device N2 in FIG. 5, the selector S2 alternatively selects the protection path P2-2 into which the multi-frame common path from a protection optical fiber F2-2 is demapped by the demapping section (MF demapper) M2-2, similarly to the above-mentioned path protection type ring network system. The selected protection path P2-2 is then outputted to the side of TB (Tributary) channel. Accordingly, path protection in this embodiment of the present invention has been achieved.

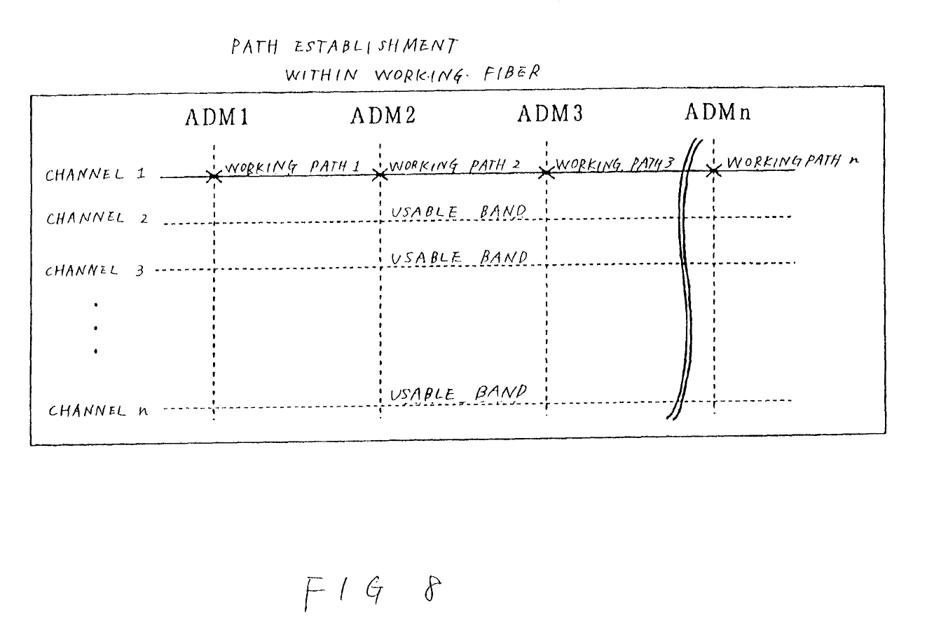

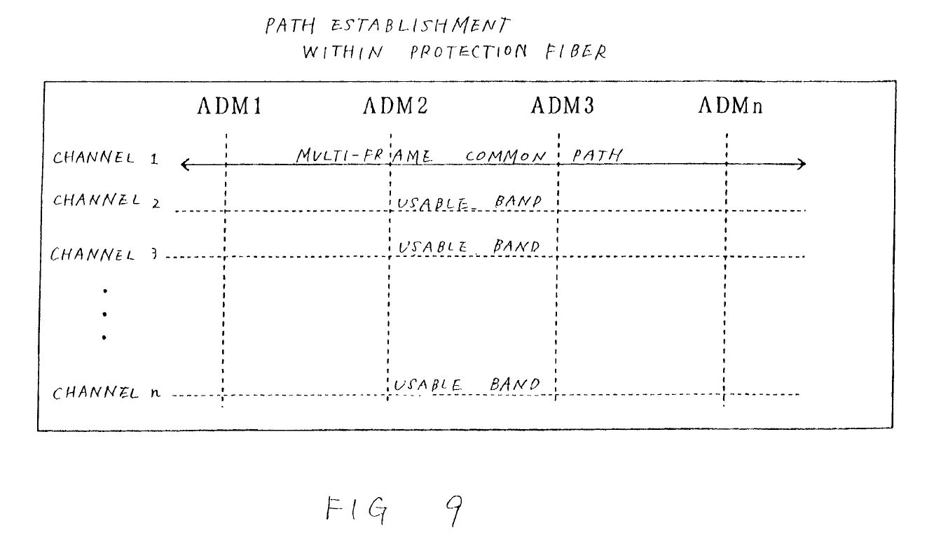

FIG. 8 shows a status of establishing paths in the working optical fiber 101 in the ring network system according to this embodiment while FIG. 9 shows a status of establishing paths in the protection optical fiber 102 therein. As illustrated in FIGS. 8 and 9, a plurality of working paths 1 to n are established on a channel 1 of the working optical fiber 101 while a multi-frame common path is established on a channel 1 (a channel of the same number as that of the channel 1 of the working optical fiber 101) of the protection optical fiber 102. In the conventional method, as shown in FIGS. 1 and 2, when paths are established hop by hop between n ADM devices, it is necessary to use n numbers of channels in an optical fiber. On the other hand, it is enough to use one channel in an optical fiber, as illustrated in FIGS. 8 and 9, in this embodiment of the present invention. Thus, it can be understood that an efficiency of use of bands in the optical fiber is drastically improved in this embodiment of the present invention.

Namely, according to the first embodiment of the present invention thus mentioned above, it becomes possible that a plurality of working paths are established on the same channel by establishing protection paths on one protection channel. Bands of an optical fiber can be used so effectively, when paths are established hop by hop in a path protection type ring network system.

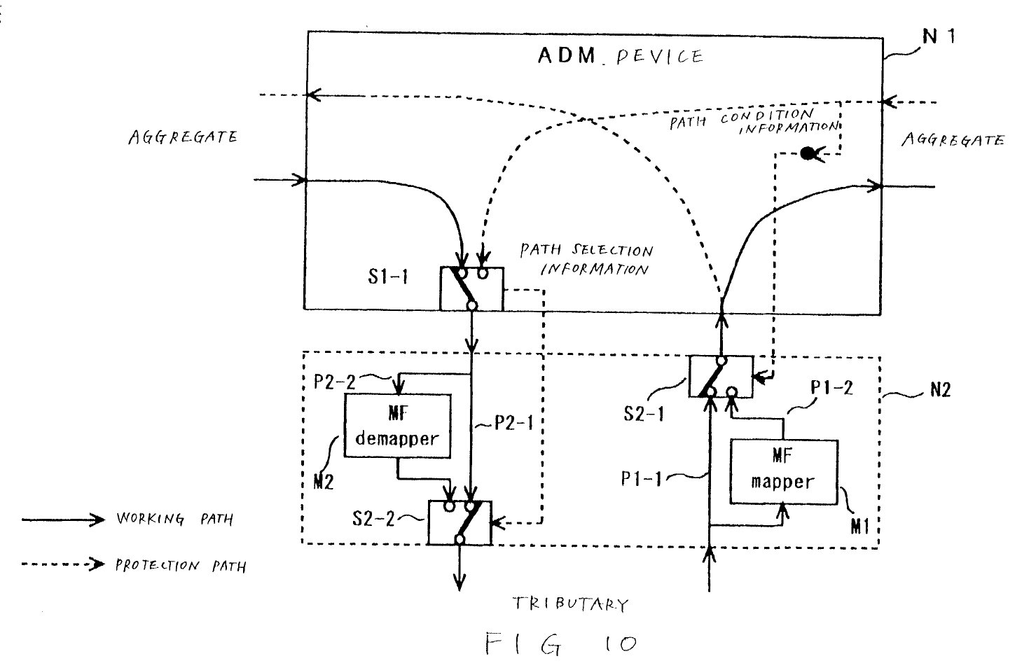

Next, referring to FIG. 10, description will proceed to a ring network system and a method of transmitting a signal in the ring network system according to a second embodiment of the present invention. FIG. 10 is a block diagram for schematically showing the ring network system according to the second embodiment of the present invention. In the second embodiment illustrated in FIG. 10, an another device having a mapping section (MF mapper) M1 and a demapping section (MF demapper) M2 or an interface module N2 is provided in addition to the ADM device N1. With the structure being illustrated, a function similar to that of the first embodiment can be provided in an another device or an interface module. It is thereby unnecessary to alter the existing ADM device.

Operations of the second embodiment will hereunder be described with reference to FIG. 10. At first, in the transmission side, a selector S2-1 in the another device or the interface module N2 selects a path P1-1 directly inputted from the side of TB (Tributary) channel, when communication condition is normal. When trouble is caused to occur in a transmission path. the selector S2-1 selects a multi-frame common path P1-2 from the mapping section (MF mapper) M1 by a trigger of path condition information. Besides, in this embodiment, it is assumed that a function of transferring SONET/SDH path alarm from the opposite device, and the like are used as the path condition information.

On the other hand, in the reception side, a selector S2-2 in the another device or the interface module N2 selects a path P2-1 directly inputted from the selector S1-1 within the ADM device N1, when communication condition is normal. When the ADM device N1 detects that trouble is caused to occur in a reception path, the ADM device N1 changes a selected path by the selector S1-1 into a protection path Linked therewith, the selector S2-2 in the another device or the interface module N2 changes a selected path into the path P2-2 through the demapping, section (MF demapper) M2 by a trigger of the path selection information.

Namely, in the second embodiment, a signal conversion device (the another device or the interface module N2) having the mapping section (MF mapper) M1, the demapping section (MF demapper) M2, a first selector S2-1 as switching means, and a second selector S2-2 as switching means is used in addition to the ADM device. In the transmission side, the selector S2-1 in the another device or the interface module N2 selects a path P1-1 directly inputted from the side of TB (Tributary) channel, when communication condition is normal. When trouble is caused to occur in a transmission path, the selector S2-1 selects a multi-frame common path P1-2 from the mapping section (MF mapper) M1 by a trigger of path condition information. In the reception side, the selector S2-2 in the another device or the interface module N2 selects a path P2-1 directly inputted from the selector S1-I within the ADM device N1, when communication condition is normal. When the ADM device N1 detects that trouble is caused to occur in a reception path, the ADM device N1 changes a selected path by the selector S1-1 into a protection path. In response to this, the selector S2-2 in the another device or the interface module N2 changes a selected path into the path P2-2 through the demapping section (MF demapper) M2 by a trigger of the path selection information. As a result, according to the second embodiment of the present invention, bands of an optical fiber can be used so effectively, similarly to the first embodiment of the present invention.

As mentioned above, according to the first and the second embodiments of the present invention, a plurality of ADM devices are connected to each other like a ring by the working optical fiber and the protection optical fiber in the ring network system. Further, a working signal is transmitted in the working optical fiber to one side thereof while a protection signal is transmitted in the protection optical fiber to the other side thereof. Moreover, the working paths between the ADM devices are established on the same channel within the working optical fiber. On the other hand, the protection paths between the

ADM devices co-use a band of one channel within the protection optical fiber.

Herein, the protection paths between the ADM devices are composed of a path having multi-frame structure.

Further, the working path is composed of SONET/SDH frame. Each of the ADM devices extracts data packet from the SONET/SDH frame inputted from the side of TB (Tributary) channel. Each of the ADM devices locates the extracted data packet on a corresponding frame of the protection path Each of the ADM devices outputs the extracted data packet to the protection optical fiber at the side of Aggregate.

Furthermore, when communication trouble is caused to occur, each of the ADM devices extracts data packet from the corresponding frame of the protection path having multi-frame structure. Each of the ADM devices locates the extracted data packet on the SONET/SDH frame. Each of the ADM devices outputs the extracted data packet to the side of TB (Tributary) channel.

Moreover a plurality of ADM devices are connected to each other like a ring by the working optical fiber and the protection optical fiber and paths are established hop by hop between the ADM devices in the ring network system. Further, a signal is transmitted in the working optical fiber to one side thereof while the same signal is transmitted in the protection optical fiber to the other side thereof. Moreover, the working paths between the ADM devices are established on the same channel within the working optical fiber. On the other hand, the protection paths between the ADM devices co-use a band of one channel within the protection optical fiber. Accordingly, bands of an optical fiber can be used so effectively, when paths are established hop by hop in a path protection type ring network system.

What is claimed is:

1. A ring network system comprising:
a working optical fiber;
a protection optical fiber;
a plurality of Add-Drop Multiplexer devices which are connected to each other like a ring by said working optical fiber and said protection optical fiber;
a working signal being transmitted in said working optical fiber to one side thereof;
a protection signal being transmitted in said protection optical fiber to the other side thereof;
working paths between said a plurality of Add-Drop Multiplexer devices being established on the same channel within said working optical fiber; and
protection paths between said a plurality of Add-Drop Multiplexer devices co-using a band of one channel within said protection optical fiber.

2. A ring network system as claimed in claim 1, wherein said protection paths between said a plurality of Add-Drop Multiplexer devices are composed of a multi-frame.

3. A ring network system as claimed in claim 2, wherein said working paths are composed of SONET/SDH frames, each of said a plurality of Add-Drop Multiplexer devices extracting data packet from said SONET/SDH frames and locating the extracted data packet in a corresponding frame of said protection path.

4. A ring network system as claimed in claim 3, wherein each of said a plurality of Add-Drop Multiplexer devices extracts the data packet from said corresponding frame of said protection path and locates the extracted data packet in said SONET/SDH frames.

5. A method of transmitting a signal in a ring network system having a working optical fiber, a protection optical fiber, and a plurality of Add-Drop Multiplexer devices which are connected to each other like a ring by said working optical fiber and said protection optical fiber, a working signal being transmitted in said working optical fiber to one side thereof, a protection signal being transmitted in said protection optical fiber to the other side thereof, said method comprising the steps of:
establishing working paths between said a plurality of Add-Drop Multiplexer devices on the same channel within said working optical fiber; and
making protection paths between said a plurality of Add-Drop Multiplexer devices co-use a band of one channel within said protection optical fiber.

6. A method of transmitting a signal as claimed in claim 5, wherein said protection paths between said a plurality of Add-Drop Multiplexer devices are composed of a multi-frame.

7. A method of transmitting a signal as claimed in claim 6, wherein said working paths are composed of SONET/SDH frames, each of said a plurality of Add-Drop Multiplexer devices extracting data packet from said SONET/SDH frames and locating the extracted data packet in a corresponding frame of said protection path.

8. A method of transmitting a signal as claimed in claim 7, wherein each of said a plurality of Add-Drop Multiplexer devices extracts the data packet from said corresponding frame of said protection path and locates the extracted data packet in said SONET/SDH frames.
